(19) United States
(12) Patent Application Publication
(10) Pub. No.: US 2003/0120513 A1
(43) Pub. Date: Jun. 26, 2003

(54) Method of facilitating access to remote health-related services, practitioners, and information

(76) Inventor: Michael Rey Samaquial, Stockton, CA (US)

Correspondence Address: HOVEY WILLIAMS TIMMONS & COLLINS, 2405 GRAND BLVD., SUITE 400, KANSAS CITY, MO, 64108

(21) Appl. No.: 10/271,647

(22) Filed: Oct. 15, 2002

Related U.S. Application Data
(60) Provisional application No. 60/329,433, filed on Oct. 15, 2001.

(51) Int. Cl. G06F 17/60; G06F 7/00; G06F 17/00

(52) U.S. Cl. 705/2; 707/104.1

(57) ABSTRACT

A method of facilitating access to and consultation with a remote healthcare practitioner or other health-related service or information provider via a real-time interactive interface and over a network. Users can search via the interface among registered remote practitioners using a variety of search parameters to select a suitable remote practitioner. During the consultation, the remote practitioner can search via the interface among registered pharmacies using a variety of parameters to identify a suitable pharmacy to send prescription information to via the interface for the user. Also during the consultation, the remote practitioner can search via the interface among registered local assistants using a variety of search parameters to identify a suitable local assistant to send to the user's location to conduct a physical examination, procedure, or other action, the results of which are communicated via the interface to the remote practitioner.

### RELATED APPLICATIONS

The present non-provisional patent application relates to, claims priority benefit of, and hereby incorporates by reference a copending provisional patent application titled “Internet Medical Consultation System”, Serial No. 60/329,433, filed Oct. 15, 2001.

### BACKGROUND OF THE INVENTION

1. Field of the Invention

The present invention relates broadly to methods of facilitating access to remote health-related services, practitioners, and information. More particularly, the present invention concerns a method of facilitating access to and consultation with remote healthcare practitioners or other health-related service or information providers via a real-time interactive interface and over a network.

2. Description of the Prior Art

It is often desirable for a person to consult with a relatively remote practitioner or other health-related service or information provider about a health-related issue. Presently, such consultation typically requires that the person travel to the remote practitioner's place of business. While alternatives are known, including telephonic communication with or house calls from the remote practitioner, the former is inherently extremely limited in its ability to convey information, and the latter is increasingly rare and is often a substantially inefficient use of the remote practitioner's time.

It will be appreciated that these conventional methods of accessing the remote practitioner suffer from a number of problems and disadvantages, including, for example, requiring that any substantive or detailed consultation be in person, which almost always requires that the person travel to the remote practitioner's place of business. Furthermore, even when such travel is possible or when an alternative method of access is employed, the remote practitioner may not have access to all needed information, including, for example, the person's past and current medical histories.

Additionally, conventional access methods do not allow for accessing specialists or other practitioners located farther away than the person is able or willing to travel. This limitation is particularly harmful to persons whose local healthcare facilities or practitioners are understaffed or too few in number; do not offer all needed services; do not offer convenient hours; are too high in cost; do not offer house calls to shut-ins, recluses, or other home-bound persons; or are otherwise effectively inaccessible to the person. Additionally, because the person is effectively limited to local practitioners, the local practitioners experience no competition which might otherwise increase quality and access and decrease costs of local healthcare services. Additionally, conventional access methods do not allow travelers to effectively access their trusted family practitioners while away from home.

Additionally, conventional access methods typically require that the person, in non-emergency situations, make an appointment days or weeks in advance, then travel to the practitioner's office, and then wait to see the practitioner, all of which is substantially inefficient and inconvenient for the person and may therefore also effectively limit access, particularly for especially busy people. Additionally, conventional access methods limit practitioners to seeing and treating only local persons, thereby effectively limiting the practitioners' business even though additional ability or capacity to service patients may be available.

Due to the above-identified and other problems and disadvantages in the art, a need exists for an improved method of facilitating access to healthcare practitioners or other healthcare or information providers.

### SUMMARY OF THE INVENTION

The present invention overcomes the above-identified and other problems and disadvantages in the prior art by providing a method of facilitating access to and consultation with a remote healthcare practitioner or other health-related service or information provider via a real-time interactive interface and over a network. The method may be implemented by a third-party service provider who administers and provides the interface and some or all of the infrastructure and administrative support required by the method. The user of the implemented method will typically be an ill person seeking medical advice from the remote practitioner, but may also be, for example, another practitioner or an academic seeking to consult on health-related issues. Similarly, the remote practitioner may be substantially any physical or mental healthcare practitioner, including, for example, a physician, a nurse, a physical trainer, a psychologist, a counselor, or an addiction specialist.

The method may be implemented using a system broadly comprising a user's computing device; a practitioner's computing device; a pharmacist's computing device; a network; a practitioner's mobile signaling device; a data storage device; and a local assistant's toolkit. The user's computing device is adapted to allow the user to access the network and communicate with the various other components of the system via the interface provided by the service provider. The practitioner's computing device similarly allows the remote practitioner to access the network and communicate with the various other components of the system via the interface. The pharmacist's computing device is adapted to allow a pharmacist to communicate with the remote practitioner, particularly with regard to a drug prescription for the user.

The network may be any local or wide area network (LAN or WAN), such as the Internet. The practitioner's mobile signaling device may be any conventional wireless communication device through which the remote practitioner can be signaled that the user desires and is awaiting a consultation. The data storage device may be any suitable conventional device, such as a server, maintained by the service provider and adapted to store data, including various databases maintained by the service provider. The local assistant's toolkit includes an image capturing device, such as, for example, a digital camera, and a variety of diagnostic tools and instrumentation needed to conduct a physical or other examination of the user appropriate to the nature of the consultation, the results of which may be communicated via the interface to the remote practitioner's computing device.

As mentioned, the service provider maintains a variety of databases on the data storage device, including, for example, a User Database of relevant personal and medical information for a plurality of registered users; a Practitioner Database of relevant personal and professional information for a plurality of registered remote practitioners; a Pharmacy and Prescriptions Database of relevant personal and professional information for a plurality of pharmacists or pharmacies, including availability and costs of various drugs; an HMO/MCI/Insurance Provider Database of relevant contact and billing information for a plurality of HMOs, MCIs, and insurance providers; a Local Assistant Database of relevant personal and professional information for a plurality of local assistants; and a Consultation Database of records of relevant information from completed consultations. All parties must register with the service provider in order to be integrated into the various databases.

Implementation of a preferred embodiment of the method of the present invention proceeds generally as follows, following the aforementioned registration of all parties with the service provider. First, the user accesses the service provider's website over the network. Once there, the user must log in before proceeding. Thereafter, the user enters the interface and may search for a remote practitioner from among some or all of the plurality of remote practitioners registered and appearing in the Practitioner Database. The user chooses from or enters appropriate search parameters, such as, for example, location, specialty, ethnicity, language, online office hours, or states or places of licensure. A list of remote practitioners satisfying these parameters is generated and presented to the user. At any time, the user can enter an Evaluations Section where, after identifying a particular remote practitioner, the user can view evaluations and reviews of that particular practitioner by other users based upon their own consultation experiences.

Ultimately, the user selects a remote practitioner, either directly or from the generated list, with which to consult. Upon such selection, the user will be linked to the remote practitioner's webpage. If the remote practitioner is absent, the user can cause the mobile signaling device to signal the remote practitioner that the user is awaiting a consultation. Once the remote practitioner has accessed the network, he or she enters a registration ID to access the interface and begin the consultation.

Thereafter the consultation takes place using modern communication security and encryption technology to privately and securely engage in a synchronous, real-time dialogue using the interface and any other suitable network communication tools, such as, for example, real-time interactive chat room technology, provided by the service provider. During the consultation, the remote practitioner can, as desired, access detailed relevant information about the user from the User Database, including, for example, the user's past and current medical histories.

Also during the consultation, the remote practitioner can, as desired, access and search the Pharmacy and Prescriptions Database and select a suitable pharmacy and send via the interface a prescription for the user to the selected pharmacy. Also during the consultation, the remote practitioner can obtain detailed information from a physical examination or other procedure by summoning a local assistant to travel to the user's location to perform the desired action.

Thus, it will be appreciated that the method of the present invention provides a number of substantial advantages over the prior art, including, for example, allowing for detailed, interactive, real-time, medical consultation with the remote practitioner without requiring physical travel to the remote practitioner's location. Furthermore, the present invention facilitates such consultation by advantageously allowing for the acquisition, implementation, and sharing of medical information and procedures in an efficient, convenient, secure, and private manner and setting.

Additionally, the present invention advantageously enhances access to specialists and to healthcare in general by allowing the user to access potentially any healthcare practitioner located anywhere. Thus, the user can, as needed or desired, access specialists or lower cost healthcare practitioners located in other areas of the same country or in other countries. Such enhanced access is particularly important for users whose local healthcare facilities or practitioners are understaffed or too few in number; do not offer certain services; do not offer convenient hours; are too high in cost; do not offer house calls to shut-ins, recluses or other home-bound persons; or are otherwise effectively inaccessible to some persons. Additionally, the present invention enhances access while advantageously lowering costs by providing a substantially centralized administration by the service provider. Thus, the present invention allows the user to “shop” the world for a remote practitioner who meets the user's particular needs. This may have the added benefit of increasing healthcare quality, access, and convenience in areas where local practitioners have previously had little or no competition. Additionally, the present invention advantageously allows travelers to access their trusted family practitioner back home.

Additionally, the present invention may be used to conveniently and cost-effectively obtain a second opinion after the user has received a first opinion through, for example, conventional access methods. Additionally, in contrast to conventional methods that require the user to make an appointment days or weeks in advance, then travel to the practitioner's office, and then wait to see the practitioner, the present invention advantageously allows for substantially immediate access to healthcare services. Thus, with the present invention, the user can reduce or eliminate inconvenience and inefficiency by making their visit to the practitioner a virtual visit. Additionally, the present invention advantageously allows practitioners to enhance their incomes through improved exposure while freeing them from their offices or other places of business and with little or no investments in additional infrastructure. Thus, consultations can, as desired, be made at any time of the day or night while at home or while traveling. Additionally, the present invention allows pharmacies to enhance their incomes through improved exposure and added convenience for the customer.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a system diagram of a system adapted for implementing a preferred embodiment of the method of the present invention;

FIG. 2 is a block diagram of a plurality of databases maintained by a service provider for implementing the preferred embodiment of the method of the present invention;

FIG. 3 is a first part of a flowchart of method steps involved in performing the preferred embodiment of the method of the present invention;

FIG. 4 is a second part of the flowchart of method steps involved in performing the preferred embodiment of the method of the present invention; and

FIG. 5 is a third part of the flowchart of method steps involved in performing the preferred embodiment of the method of the present invention.

### DETAILED DESCRIPTION OF A PREFERRED EMBODIMENT

Referring to the figures, a method of facilitating access to remote health-related services, practitioners, and information is disclosed in accordance with a preferred embodiment of the present invention. More particularly, the present invention concerns a method of facilitating access to and consultation with a remote healthcare practitioner or other health-related service or information provider via a real-time interactive interface and over a network. The method may be implemented by a service provider who administers and provides the interface and some or all of the infrastructure and administrative support required by the method. The service provider may be a third-party not otherwise involved in the healthcare industry, or may, for example, be an HMO, MCI, or insurance provider attempting to decrease costs while increasing value. The user of the service will typically be an ill person seeking medical advice from the remote practitioner, but may also be, for example, another practitioner or an academic seeking to consult on health-related issues. Similarly, the remote practitioner might be substantially any physical or mental healthcare practitioner, including, for example, a physician, a nurse, a physical trainer, a psychologist, a counselor, or an addiction specialist.

As used herein, the term “remote” denotes subjective, objective, substantial, practical, effective, or actual inaccessibility to the user. Thus, the remote practitioner may in fact be located within the same city as the user, but the user is, for some reason, unable or unwilling to travel to the remote practitioner's actual location or place of business.

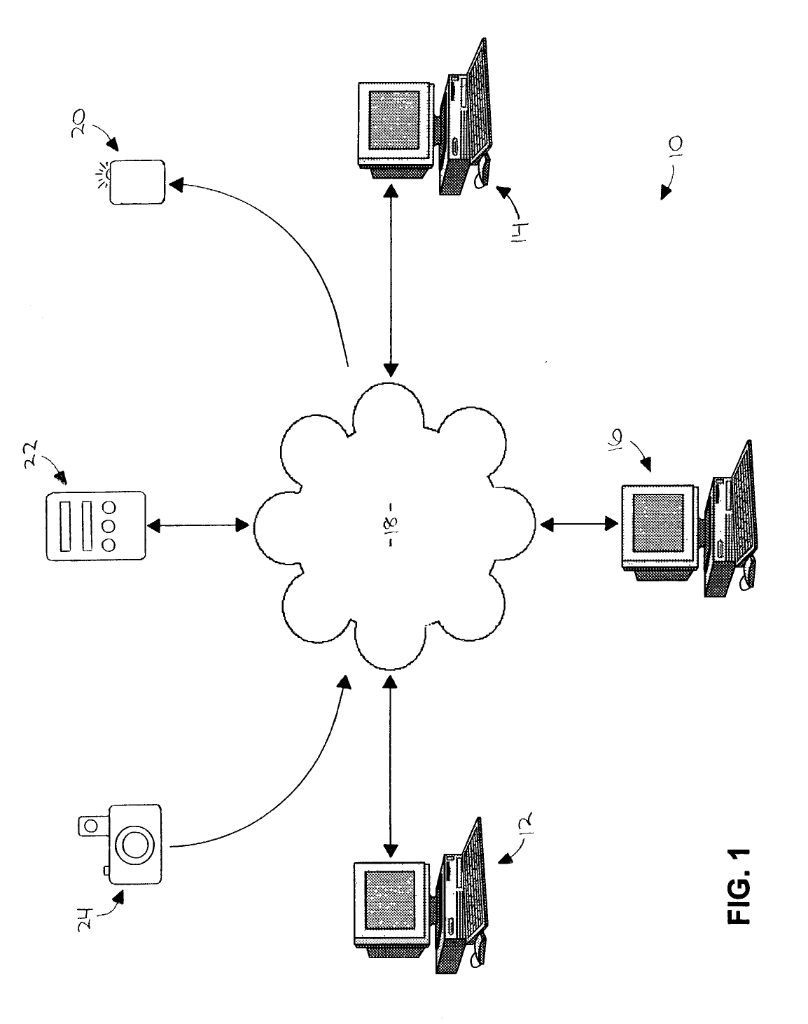

Referring particularly to FIG. 1, a system 10 is shown adapted to implement the method of the present invention. The system 10 broadly comprises a user's computing device 12; a practitioner's computing device 14; a pharmacist's computing device 16; a network 18; a practitioner's mobile signaling device 20; a data storage device 22; and a local assistant's toolkit 24.

The user's computing device 12 is adapted to allow the user to access the network 18 and communicate with the various other components of the system 10. The practitioner's computing device 14 is located remotely from the user's computing device 12 but is similarly functional in that it allows the remote practitioner to access the network 18 and communicate with the various other components of the system 10. The pharmacist's computing device 16 is adapted to allow a pharmacist to communicate with the remote practitioner, particularly with regard to a drug prescription for the user. All such computing devices 12, 14, 16 are substantially conventional in form and function and may, for example, be personal desktop or laptop computers, terminals, thin-client terminals, hand-held computing devices, capable wireless communications devices, or any other suitable and commonly available computing device adapted to receive and transmit information over the network 18. Additionally, in one embodiment, the user's computing device 12 may be provided in kiosk or booth form at, for example, a local pharmacy or shopping center.

The network 18 may be any local or wide area network (LAN or WAN), such as the Internet. The practitioner's mobile signaling device 20 may be any conventional wireless communication device, such as, for example, a pager, cellular telephone, or mobile electronic mail device, through which the remote practitioner can be signaled that the user desires and is awaiting a consultation. The data storage device 22 is any suitable substantially conventional device, such as a server, maintained by the service provider and adapted to store data, such as the user's medical history, and accessible by the practitioner's computing device 14 via the network 18. The data storage device 22 may be a central or regional repository of information relevant to consultations between users and remote practitioners.

The local assistant's toolkit 24 includes an image capturing device, such as, for example, a digital camera, and a variety of diagnostic tools and instrumentation needed to conduct a physical or other examination of the user or other procedure appropriate to the nature of the consultation, the results of which are communicated to the practitioner's computing device 14 via the interface. The concept of the local assistant is discussed below in greater detail.

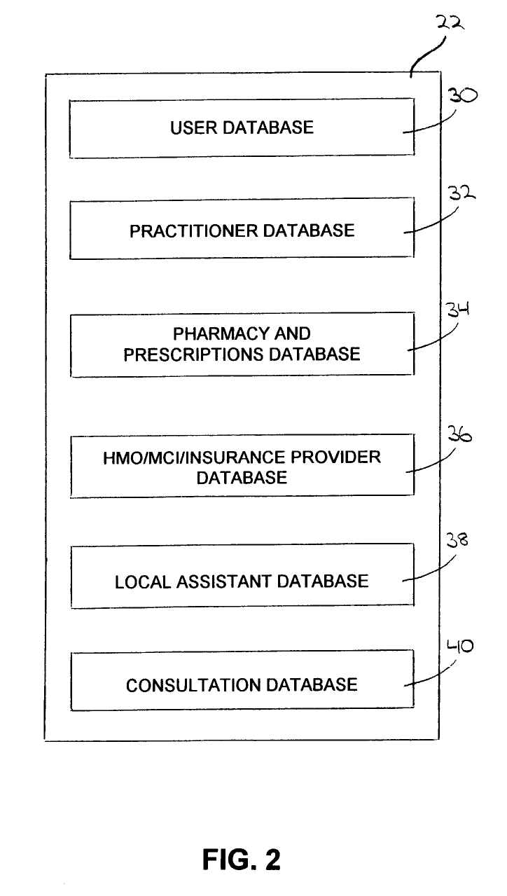

Referring also to FIG. 2, the service provider maintains a variety of databases on the data storage device 22, including, for example, a User Database 30 of relevant personal and medical information for a plurality of registered users; a Practitioner Database 32 of relevant personal and professional information for a plurality of registered remote practitioners; a Pharmacy and Prescriptions Database 34 of relevant personal and professional information for a plurality of pharmacists or pharmacies, including availability and costs of drugs; an HMO/MCI/Insurance Provider Database 36 of relevant contact and billing information for a plurality of HMOs, MCIs, or insurance carriers; a Local Assistant Database 38 of relevant personal and professional information for a plurality of local assistants; and a Consultation Database 40 of records of relevant information from past consultations. The user, the remote practitioner, the pharmacies and pharmacists, the HMO's, MCI's, and insurance providers, and the local assistants must all register with the service provider in order to be integrated into the various databases. Registration may also include agreeing to an appropriate Use Agreement addressing potential legal issues between, for example, the service provider and the registering party.

The service provider, being the facilitator of the consultation, may also handle billing. Thus, the user's registration, for example, allows the service provider to bill the user's registered HMO or other insurance provider directly for the user's use of the service.

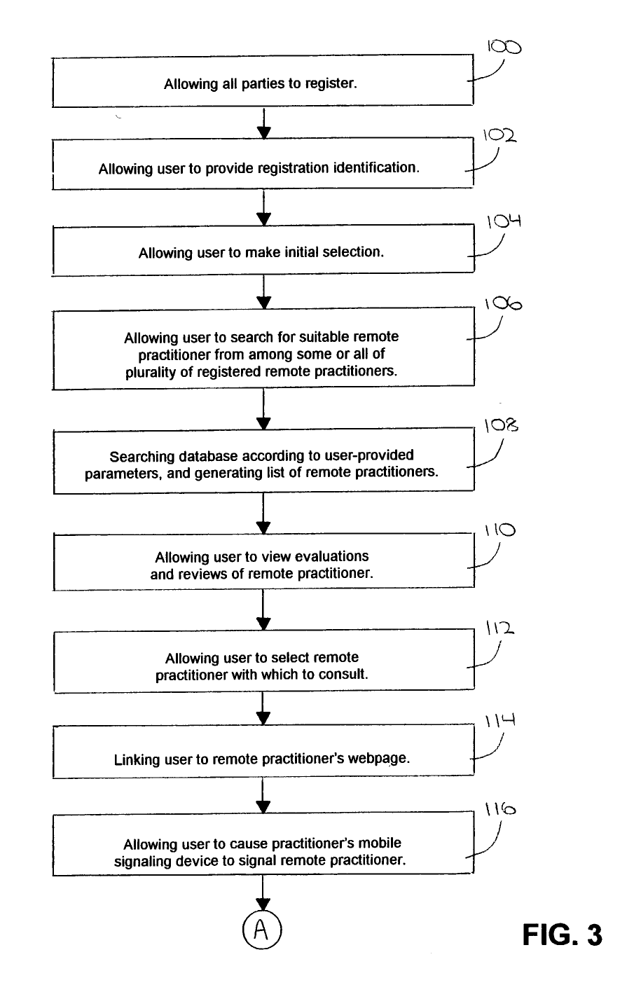

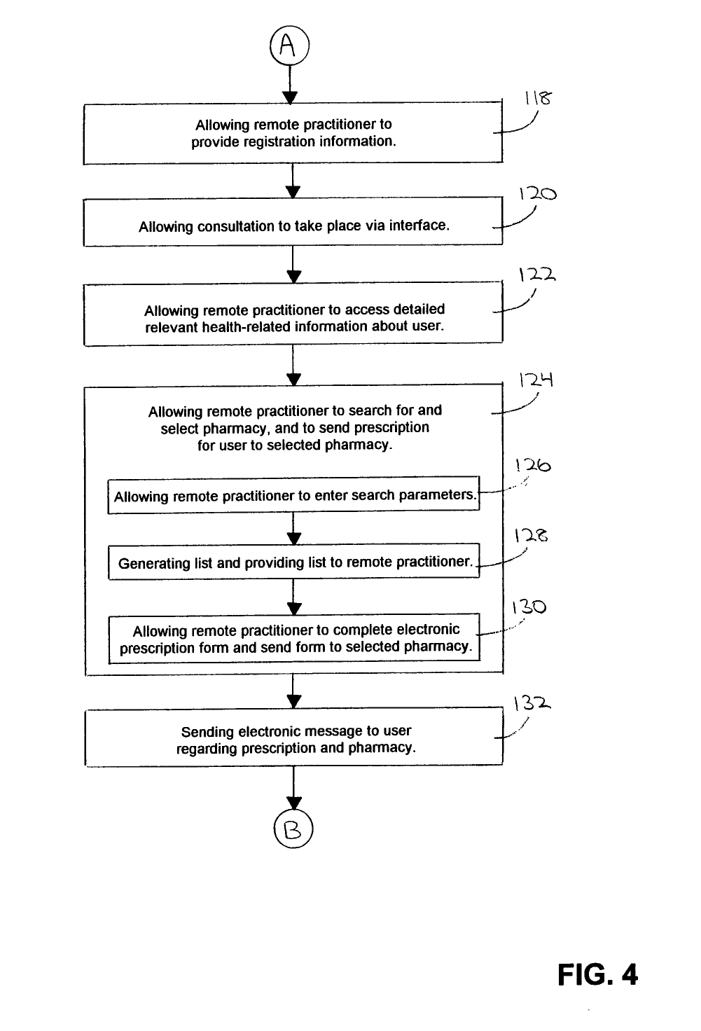

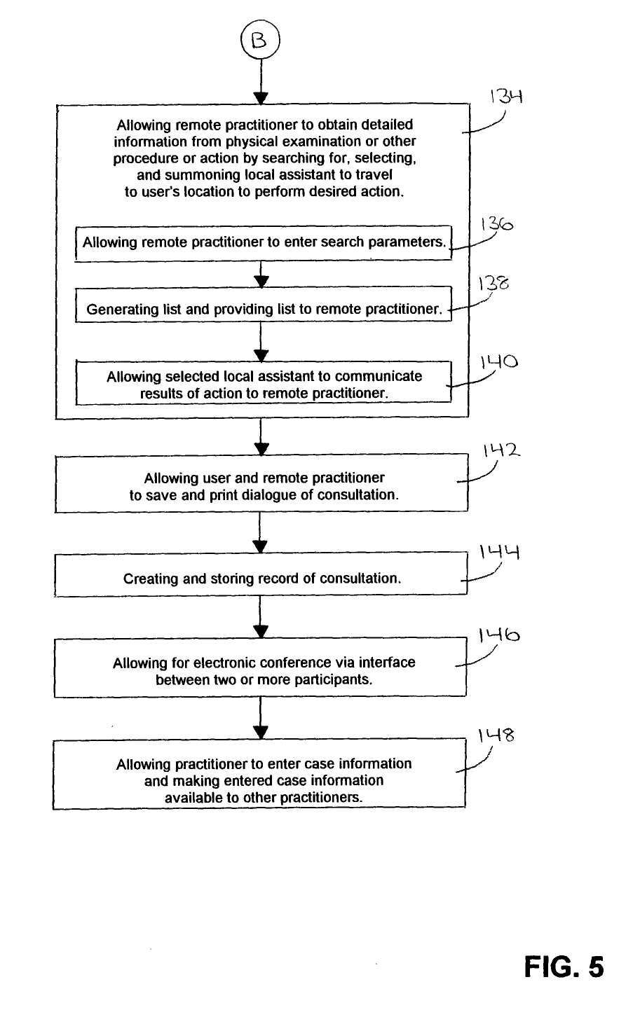

Referring also to FIGS. 3, 4, and 5, implementation of a preferred embodiment of the method of the present invention proceeds generally as follows, following the aforementioned registration of all parties with the service provider, as depicted in box 100.

First, the user accesses the service provider's website via the network 18. Once there, the user must log in by providing their registration identification (e.g., insurance number) before beginning a session or otherwise proceeding, as depicted in box 102.

Once logged in, the user enters the interface and may indicate a desired area of interest: HMOs/MCIs/Insurance Providers; Healthcare Practitioners; or Academics, as depicted in box 104. If the user chooses the area of HMOs/MCIs/Insurance Providers, the user must indicate a specific HMO, MCI, or insurance provider. Each HMO, MCI, and insurance provider may have their own databases for approved remote practitioners, pharmacies or pharmacists and drugs, and local assistants. If the user chooses the area of Healthcare Practitioners, the user can access all of the plurality of remote practitioners registered and appearing in the Practitioner Database 32. If the user chooses Academics, the user, who is likely to be a healthcare practitioner, can access only those remote practitioners who are listed as academics, educators, or researchers available for consultation with other healthcare practitioners.

The user may then search for a suitable remote practitioner from among some or all of the plurality of remote practitioners registered and appearing in the Practitioner Database 32, as depicted in box 106. The user chooses from or enters appropriate search parameters, such as, for example, location, specialty, ethnicity, language, online office hours, or states or places of licensure. The Practitioner Database 32 is then searched based on these search parameters and a list is generated and presented to the user, as depicted in box 108.

At any time, the user can enter an Evaluations Section where, after identifying a particular remote practitioner (e.g., from the aforementioned list), the user can view evaluations and reviews of that particular remote practitioner, as depicted in box 110. More specifically, the Evaluations Section gives the user access to relevant general information about the remote practitioner as well as other users' evaluations and reviews of the remote practitioner based upon their own consultation experiences. The general information might include, for example, the remote practitioner's specialty or particular areas of expertise, credentials, ethnicity, office addresses, place of licensure, online office hours, and language. A personal statement provided by the remote practitioner may be included as well. The information provided by the Evaluations Section may be stored in the Practitioner Database 32 or in another database, as desired. Both the user and the remote practitioner can access the Evaluations Section. The remote practitioner can update his or her general information and review the users' evaluations, while the user can submit personalized comments and complete evaluations and questionnaire forms which may include a rating scheme for typical concerns and experiences, including, for example, the following:

length of time user waited for practitioner to begin consultation;

effectiveness or helpfulness of advice provided by practitioner;

courtesy and professionalism shown by practitioner;

level of knowledge or expertise demonstrated by practitioner;

willingness of practitioner to provide prescriptions or other therapeutic alternatives;

willingness of user to recommend practitioner to another user; and

willingness of user to return to the practitioner for another consultation.

Ultimately, the user must select a remote practitioner, either directly or from the generated list, with which to consult, as depicted in box 112. Upon such selection, the user will be linked to the remote practitioner's webpage, as depicted in box 114. The remote practitioner's webpage presents relevant general information about the remote practitioner as well as a digital photograph of the remote practitioner. Additional information may be presented using substantially any suitable medium, including, for example, video, still images, animation, audio, or text. Using the interface, the user may indicate (e.g., by selecting a virtual button or other control) that a consultation is a desired.

If the remote practitioner is absent, the user can via the interface cause (e.g., by selecting a virtual button or other control) the practitioner's mobile signaling device 20 to signal the remote practitioner that the user is awaiting a consultation, as depicted in box 116. Once the remote practitioner has accessed the network 18 and is ready to open a dialogue with the user, the remote practitioner must enter their registration identification (e.g., license number) prior to gaining access to the interface and proceeding, as depicted in box 118.

Thereafter the consultation takes place using modern communication security and encryption technology to privately and securely engage in a synchronous, real-time dialogue using the interface and any other appropriate network communication tools, such as, for example, real-time interactive chat room technology, provided by the service provider, as depicted in box 120.

During the consultation, the remote practitioner can, as desired, access detailed relevant information about the user from the User Database 30, as depicted in box 122, including, for example:

the user's past medical history, including—

past illnesses and other healthcare issues,

names and addresses of past practitioners,

past results of laboratory tests, examinations, and procedures,

food and drug allergies,

past medications and the prescribing practitioners; and

the user's current medical history, including—

current illness and duration,

names and address of current practitioners,

current results of laboratory tests, examinations, and procedures,

current medications and prescribing practitioners.

The user is also able to access this information from the Users Database 32, and can, as desired, update, change, or otherwise edit the information (practitioners may or may not be allowed to edit the information in the User's Database 32).

It will be appreciated that the method of the present invention is substantially enabled by the Users Database 32 because it provides the remote practitioner with immediate access to the user's past and current health records, without which the consultation might be impossible or at least substantially delayed while such access was obtained.

Also during the consultation, the remote practitioner can, as desired, access the Pharmacy and Prescriptions Database 34 and select a suitable pharmacy and send via the interface a prescription for the user to the selected pharmacy, as depicted in box 124. The remote practitioner can search the Pharmacy and Prescriptions Database 34 using any appropriate search parameters, including, for example, city, state, zip code, drug availability, drug cost, and, as applicable, approval by the user's HMO, MCI, or insurance provider, as depicted in box 126. A list of matching pharmacies is generated based on the search parameters and provided to the remote practitioner, as depicted in box 128. Thus, for example, the list may include only pharmacies in the specified locale that are approved by the specified HMO, MCI, or insurance provider and that carry the specified drugs at or below the specified cost. The remote practitioner then chooses, possibly with input from the user, a pharmacy from the list.

The remote practitioner then selects a hyperlink associated with the chosen pharmacy which causes to appear an electronic form. The remote practitioner then fills out the form, including information substantially similar to a conventional prescription, and electronically sends the form via the interface to the chosen pharmacy, as depicted in box 130. An electronic message may be sent to the user containing the prescription information and indicating the pharmacy location, as depicted in box 132. Thereafter the user can receive the prescribed medication from the pharmacy.

Also during the consultation, the remote practitioner can obtain detailed information from a physical examination or other procedure or action by summoning a local assistant to travel to the user's location to perform the action, as depicted in box 134. The local assistant is initially identified by searching the Local Assistant Database 38 using such search parameters as, for example, state, county, city, and times available, as depicted in box 136. A list is generated from the search and provided to the remote practitioner to choose a suitable local assistant, as depicted in box 138. Following selection and notification (by e.g., pager, email, or telephone) of the local assistant and upon his or her arrival at the user's location, the local assistant enters the consultation via the interface using the user's or another computing device and their own registration number; employs the local assistant's toolkit 24 to perform the physical examination, procedure, or other action requested by the remote practitioner; and sends or transfers via the interface to the remote practitioner the images and other information resulting therefrom, as depicted in box 140.

The service provider maintains records of the local assistant's work or house call and adds any relevant information to the appropriate database(s). The service provider may also bill based upon these records, particularly the duration of the house call and the services performed and the materials used.

At the end of the consultation, the dialogue can be saved and printed, as desired, by both the user and the remote practitioner, as depicted in box 142. The service provider maintains a file for each remote practitioner containing relevant log information, including, for example, a total number and dates of consultations; names of users consulted with; and names of users' HMOs, MCIs, or insurance providers, as appropriate. This file is updated regularly each time the remote practitioner ends a session, and may be stored in the Practitioner Database 32 or in another database, as depicted in box 144.

In addition to the aforementioned features, the present invention contemplates a variety if complementary features, including for example a Practitioner Conference feature and a Case Study feature. The Practitioner Conference feature allows two or more remote practitioners to engage in a secure conference via the interface and using chatroom technology, as depicted in box 146. This feature may also be used by medical product suppliers and service providers to make presentations via the interface to a group of remote practitioners. This feature may also be used to provide continuing medical education via the interface to groups of remote practitioners. This feature is particularly advantageous to remote practitioners who are too busy or too far away to attend the aforementioned events in person.

The Case Study feature allows practitioners to enter via the interface certain case information for later reference by other practitioners, as depicted in box 148. This feature is particularly useful when the case involves rare, unique, or otherwise uncommon medical issues.

From the preceding description it will be appreciated that the method of the present invention provides a number of substantial advantages over the prior art, including, for example, allowing for detailed, interactive, real-time, medical consultation with the remote practitioner without requiring physical travel to the remote practitioner's location. Furthermore, the present invention facilitates such consultation by advantageously allowing for the acquisition, implementation, and sharing of medical information and procedures in an efficient, convenient, secure, and private manner and setting.

Additionally, the present invention advantageously enhances access to specialists and to healthcare in general by allowing the user to access potentially any healthcare practitioner located anywhere. Thus, the user can, as needed or desired, access specialists or lower cost healthcare practitioners located in other areas of the same country or in other countries. Such enhanced access is particularly important for users whose local healthcare facilities or practitioners are understaffed or too few in number; do not offer certain services; do not offer convenient hours; are too high in cost; do not offer house calls to shut-ins, recluses or other home-bound persons; or are otherwise effectively inaccessible. Additionally, the present invention enhances access while advantageously lowering costs by providing a substantially centralized administration. Thus, the present invention allows the user to “shop” the world for a remote practitioner who meets the user's particular needs. This may have the added benefit of increasing healthcare service, access, and convenience in areas where local practitioners have previously had little or no competition. Additionally, the present invention advantageously allows travelers to access their trusted family practitioner back home.

Additionally, the present invention may be used to conveniently and cost-effectively obtain a second opinion after the user has received a first opinion through, for example, conventional access methods. Additionally, in contrast to conventional methods that require the user to make an appointment days or weeks in advance, then travel to the practitioner's office, and then wait to see the practitioner, the present invention advantageously allows for substantially immediate access to healthcare. Thus, the user can reduce or eliminate the inconvenience and inefficiency by making their visit to the practitioner a virtual visit. Additionally, the present invention advantageously allows practitioners to enhance their incomes through improved exposure while freeing them from their offices or other places of business and with little or no investments in additional infrastructure. Thus, consultations can, as desired, be made at any time of the day or night while at home or while traveling. Additionally, the present invention allows pharmacies to enhance their incomes through improved exposure and added convenience for the customer.

Although the invention has been described with reference to the preferred embodiments illustrated in the drawings, it is noted that equivalents may be employed and substitutions made herein without departing from the scope of the invention as recited in the claims. Thus, for example, it will be appreciated that the various components of the system 10 as well as the various databases 30,32,34,36,38,40 maintained by the service provider may be combined or otherwise adapted or changed without departing from the contemplated scope of the method of the present invention.

Having thus described the preferred embodiment of the invention, what is claimed as new and desired to be protected by Letters Patent includes the following:

1. A method of facilitating access by a user to health-related information provided by a remote practitioner, the method comprising the steps of:
(a) maintaining a first database of a plurality of practitioners;
(b) maintaining a second database of a plurality pharmacies;
(c) maintaining a third database of a plurality of local assistants;
(d) providing an interface allowing for substantially real-time and interactive communication over a network;
(e) allowing the user to search via the interface the first database and to select the remote practitioner from the plurality of practitioners;
(f) allowing the remote practitioner to search via the interface the second database and to select a pharmacy from the plurality of pharmacies;
(g) allowing the remote practitioner to communicate via the interface a prescription for the user to the pharmacy;
(h) allowing the remote practitioner to search via the interface the third database and to select a local assistant from the plurality of local assistants;
(i) allowing the remote practitioner to request via the interface that the local assistant travel to the user to perform an action;
(j) allowing the local assistant to communicate via the interface a result of the action to the remote practitioner; and
(k) maintaining a record of the communication via the interface.

2. The method as set forth in claim 1, further including the step of allowing the user to submit via the interface an evaluation of the remote practitioner, and the step of allowing other users to view via the interface the evaluation of the remote practitioner.

3. The method as set forth in claim 1, further including the step of allowing the user and the remote practitioner to print a record of the communication via the interface.

4. The method as set forth in claim 1, further including the step of allowing the remote practitioner to engage via the interface in a conference with other remote practitioners.

5. The method as set forth in claim 1, further including the step of allowing the remote practitioner to enter via the interface a case study concerning the consultation, and the step of allowing other remote practitioners to view via the interface the case study.

6. A method of facilitating access by a user to health-related information provided by a remote practitioner, the method comprising the steps of:
(a) maintaining a first database of a plurality of practitioners;
(b) maintaining a second database of a plurality pharmacies;
(c) maintaining a third database of a plurality of local assistants;
(d) providing an interface allowing for substantially real-time and interactive communication over a network;
(e) allowing the user to search via the interface the first database and to select the remote practitioner from the plurality of practitioners;
(f) allowing the remote practitioner to search via the interface the second database and to select a pharmacy from the plurality of pharmacies;
(g) allowing the remote practitioner to communicate via the interface a prescription for the user to the pharmacy;
(h) allowing the remote practitioner to search via the interface the third database and to select a local assistant from the plurality of local assistants;
(i) allowing the remote practitioner to request via the interface that the local assistant travel to the user to perform an action;
(j) allowing the local assistant to communicate via the interface a result of the action to the remote practitioner;
(k) maintaining a record of the communication via the interface;
(l) allowing the user to submit via the interface an evaluation of the remote practitioner; and
(m) allowing other users to view via the interface the evaluation of the remote practitioner.

7. The method as set forth in claim 6, further including the step of allowing the user and the remote practitioner to print a record of the communication via the interface.

8. The method as set forth in claim 6, further including the step of allowing the remote practitioner to engage via the interface in a conference with other remote practitioners.

9. The method as set forth in claim 6, further including the step of allowing the remote practitioner to enter via the interface a case study concerning the consultation, and the step of allowing other remote practitioners to view via the interface the case study.

10. A method of facilitating access by a user to health-related information provided by a remote practitioner, the method comprising the steps of:
(a) maintaining a first database of a plurality of practitioners;
(b) maintaining a second database of a plurality pharmacies;
(c) maintaining a third database of a plurality of local assistants;
(d) providing an interface allowing for substantially real-time and interactive communication over a network;
(e) allowing the user to search via the interface the first database and to select the remote practitioner from the plurality of practitioners;
(f) allowing the remote practitioner to search via the interface the second database and to select a pharmacy from the plurality of pharmacies;
(g) allowing the remote practitioner to communicate via the interface a prescription for the user to the pharmacy;
(h) allowing the remote practitioner to search via the interface the third database and to select a local assistant from the plurality of local assistants;
(i) allowing the remote practitioner to request via the interface that the local assistant travel to the user to perform an action;
(j) allowing the local assistant to communicate via the interface a result of the action to the remote practitioner;
(k) maintaining a record of the communication via the interface;
(l) allowing the user to submit via the interface an evaluation of the remote practitioner;
(m) allowing other users to view via the interface the evaluation of the remote practitioner;
(n) allowing the user and the remote practitioner to print a record of the communication via the interface;
(o) allowing the remote practitioner to engage via the interface in a conference with other remote practitioners; and
(p) allowing the remote practitioner to enter via the interface a case study concerning the consultation, and the step of allowing other remote practitioners to view via the interface the case study.
